(19) United States
(12) Patent Application Publication
(10) Pub. No.: US 2012/0321776 A1
(43) Pub. Date: Dec. 20, 2012

(54) PROCESS FOR IN SITU PLASMA POLYMERIZATION OF SILICONE COATINGS FOR SURGICAL NEEDLES

(76) Inventor: Robert Vetrecin, Stewartsville, NJ (US)

(21) Appl. No.: 13/162,837

(22) Filed: Jun. 17, 2011

(51) Int. Cl. B05D 7/00; B05D 3/00; B05D 3/10

(52) U.S. Cl. 427/2.1

(57) ABSTRACT

A novel method of in situ curing of silicone polymer coatings on surfaces of medical devices, such as surgical needles. The method provides for curing the coatings using a plasma.

### FIELD OF THE INVENTION

The field of art to which the present invention relates is processes for curing coatings, more specifically, processes for curing silicone coatings on medical devices such as surgical needles.

### BACKGROUND OF THE INVENTION

Surgical needles are well known in the art. The needles typically have pointed distal tissue piercing ends and proximal suture mounting ends. The proximal suture mounting ends may have bore holes or channels for receiving the distal end of a surgical suture, which is then affixed to the bore hole or channel in a conventional manner, including mechanically swaging, gluing, etc. Surgical needles conventionally have a curved or straight configuration to facilitate suturing of a wound or other tissue approximation procedures. Surgical needles may also have cutting edges to facilitate passage through tissue.

Surgical needles are conventionally provided with lubricious coatings during manufacturing. One of the primary reasons for applying such coatings to surgical needles is the reduction of tissue drag. It is known that the addition of a hydrophobic surface, such as those produced by a silicone-based coating, further enhances the ability of a lubricious coating to minimize tissue drag. The coatings may be applied in a variety of conventional manners including dipping, spraying, curtain coating processes, etc. Coatings for surgical needles need to have several characteristics in order to be useful. The coatings must be biocompatible, and must provide the desired lubricity. The coatings must also provide ease of application during manufacturing, and must be readily curable. In addition, the coatings need to be durable in order to withstand multiple passes through tissue.

Silicone coatings conventionally used to coat surgical needles are typically cured using known thermal curing processes, including heating in an air oven, nitrogen oven, or vacuum oven. Curing is performed at high temperatures, for example, up to 200° C., and for a sufficient time to provide desired curing that may range, for example, from several hours to up to several hundred hours. A conventional catalyst consisting of an organo platinum complex, dibutyl tin dilaurate, or stannous octoate can optionally be added to the coating composition to shorten the curing or cross-linking reaction time.

Existing curing processes are known to suffer from several deficiencies. One known deficiency is associated with the non-uniformity of the thermal field and the associated lack of predictability of the curing outcome. In addition, processes that utilize curing catalysts may have potential biocompatibility issues, such as, for example, when using a platinum catalyst. In addition, catalysts used in coatings may adversely affect processing. Thermal curing processes utilizing ambient air may also lead to exposure to excess moisture during processing or process transfer steps, resulting in a loss of cross-linking capability, thus resulting in a degradation of coating performance. Additionally, thermal curing processes may lead to thermal decomposition of the silicone hydride, if present. It is also known that thermal curing reactions can be variable, and often long reaction times are necessary. This may result in a lack of reproducibility because of the long reaction times that could result in an unreliable thermal curing history.

As previously mentioned, it is known to coat surgical needles with conventional lubricious coatings. Such coatings include conventional polymeric silicones and siloxanes, including polymers such as polydimethylsiloxane, having a variety of different end groups and molecular weights. The coatings may also contain conventional additives such as cross-linking agents, catalysts, etc. These coating additives help to ensure that the silicones and siloxanes have adequate adhesion and durability when used as needle coatings.

Silicone coatings for medical devices, including surgical needles, are described in U.S. Pat. No. 7,041,088, which discloses a medical device having a contact surface exposed repeatedly to bodily tissue, the contact surface being coated with a coating mixture comprising from about 40 weight percent to about 86 weight percent of a silicone polymer and from about 14 weight percent to about 60 weight percent of a non-silicone hydrophobic polymer. U.S. Pat. No. 6,936,297 discloses a method for manufacturing a siliconized surgical needle consisting of the steps of providing a surgical needle having a tissue penetrating end, a suture attachment end, and a surface, and applying a coating mixture on the surface of the needle. The coating mixture consists of an organic solvent, at least one polydialkylsiloxane having a molecular weight sufficient to provide a viscosity to the coating mixture of at least about 10,000 cp, and at least one other siliconization material. The coating mixture is cured on the surface of the needle to provide a silicone coating thereon. U.S. Published Patent Application No. 20110112565 discloses a method for coating a medical device. The method consists of providing a medical device and applying a homogenous coating to at least a portion of a surface of the medical device with a thickness in the range of about 1 micron to about 12 microns. The homogenous coating consists of a vinyl functionalized organopolysiloxane and a polydimethylsiloxane.

U.S. Pat. No. 5,944,919 discloses a process for blackening the surfaces of a metal alloy surgical needle or a metal alloy surgical instrument. The process consists of exposing the surfaces of a metal alloy surgical needle or surgical instrument to a gaseous plasma for a sufficient amount of time to effectively blacken the surfaces of the needle or instrument.

In the medical device arts, the use of plasma treatments for implantable medical devices made from biocompatible materials has generally been confined to surface conditioning, i.e., altering functional groups on the surface of the devices, without attention to the surface morphology. Surface modifications for implants and other devices by radio frequency (RF) plasmas are found in the following U.S. Pat. Nos. 3,814,983; 4,929,319, 4,948,628; 5,055,316; 5,080,924; 5,084,151; 5,217,743; 5,229,172; 5,246,451; 5,260,093; 5,262,097; 5,364,662; 5,451,428; 5,476,509; and 5,543,019.

U.S. Pat. No. 6,558,409 discloses a method for coating a surgical needle comprising the steps of providing a surgical needle having a surface, and forming a polymer coating on at least a portion of the surface of the needle by plasma polymerization of a hydrocyclosiloxane monomer.

U.S. Pat. No. 7,553,529 discloses an article having reduced break-out force and reduced sliding frictional force consisting of one or more surfaces having a lubricant applied to at least one of the surfaces, the lubricant including a polysiloxane-based compound. The lubricant-coated surface is subsequently exposed to an energy source at about atmospheric pressure, wherein the energy source is an ionizing gas plasma.

U.S. Pat. No. 5,364,662 discloses a method for modifying the surface of a polydimethylsiloxane silicone rubber. The method consists of the step of treating the silicone rubber in a plasma, which is substantially free of oxygen and under conditions that do not strip reactive hydrogen groups from the silicone rubber surface in order to produce Si—H moieties on the surface thereof.

U.S. Pat. No. 6,765,069 discloses a plasma cross-linked hydrophilic and lubricious coating consisting of a hydrophilic polymeric unit cross-linked in situ with a plasma deposited double bond monomer.

U.S. Pat. No. 6,630,243 discloses a method for treating a surface of a silicone medical device having the following steps: (a) subjecting the surface of the silicone medical device to a plasma-polymerization reaction in a hydrocarbon-containing atmosphere to form a polymeric carbonaceous layer on the surface of the silicone medical device having a thickness of 50 to 500 Angstroms; (b) forming reactive functionalities on the surface of the carbonaceous layer; and (c) exposing the surface of the silicone medical device to a solution of a hydrophilic reactive polymer having complementary reactive functionalities on the carbonaceous layer, thereby forming a biocompatible surface on the silicone medical device, wherein the silicone medical device is a silicone contact lens or silicone intraocular device.

U.S. Pat. No. 5,463,010 discloses plasma polymerized membranes consisting of polymerized aliphatic hydrocyclosiloxane monomers, optionally copolymerized with co-monomers, and methods for their preparation. The membranes are formed from the plasma polymerization of hydrocyclosiloxane monomers.

In addition to the deficiencies associated with conventional thermal curing processes mentioned above, and although processes for treating silicone coatings on surfaces of medical devices with plasmas or coating surfaces with silicone coatings using plasmas are known, there are deficiencies associated with the use of such conventional plasma processes. For example, processes for coating medical devices in plasma environments are believed to have deficiencies associated with the use of monomers reacting in a gas phase and then condensing on the surfaces of the device. These processes are thought to have low build rates and require long reaction times to produce coatings thick enough for efficacy. It is also known that plasma treatments used in the prior art may have the potential to degrade the coatings.

Accordingly, there is a need in this art for novel processes for curing silicone coatings on surfaces of medical devices, including surgical needles.

### SUMMARY OF THE INVENTION

A Novel process for curing silicone coatings on surfaces of medical devices such as surgical needles are disclosed. In this process, a silicone coating is first applied to a surface of a medical device. The silicone coating does not contain a catalyst. Then, the coated surface is exposed to a plasma such that the coating is cured to form a durable, lubricious coating. Optionally, the coating is dried prior to plasma treatment. It is particularly preferred to utilize the novel processes of the present invention for surgical needles.

These and other features and advantages of the present invention will become more apparent from the following description and accompanying drawings.

### BRIEF DESCRIPTION OF THE DRAWINGS

FIG. 1 shows a schematic block-diagram of a needle coating process according to an embodiment of the present invention.

FIG. 2 shows an experimental plot of force applied to coated needles (made in accordance with Examples 1-3) required to pass through simulated tissue medium as a function of distance, and the number of passes through the media; the testing was done in accordance with Example 4.

FIG. 3 is a graph that shows a comparison of needle drag as a function of the number of passes for needles with a plasma-treated coating in accordance with the present invention versus needles with a heat treated coating in accordance with Example 5 and versus uncoated needles.

FIG. 4 is a graph that shows the results of the testing of needles coated with RF plasma cured coatings, with variable exposure to RF treatment, and with ten passes through the test media in accordance with Example 6.

### DETAILED DESCRIPTION OF THE INVENTION

### Surface Preparation

The surfaces of the medical devices that may be treated using the novel process of the present invention, including but not limited to surgical needles, will typically be cleaned prior to coating using conventional cleaning processes. These cleaning processes may include, for example, vapor degreasing in a fluorocarbon-containing process followed by an alkaline cleaning step, and rinsing and drying. The cleaning can also be facilitated using conventional appropriate plasma cleaning processes. Cleaning may be optional, depending upon the condition of the surfaces.

### Substrates

The medical devices that can be coated using the coatings and processes of the present invention may be formed from various conventional biocompatible materials including, without limitation, austenitic or martensitic stainless steels such as 304ss, 316ss, 420ss, 455ss, ETHALLOY metal alloy (or any stainless steel described in ASTM F 899), refractory alloys, ceramics, glasses, and biocompatible polymers including polyolefins and fluorinated polymers such as polyvinylidene fluoride. The medical devices may also include combinations of these materials and composite materials. The medical devices that can be coated with silicone polymer coatings using the processes of the present invention include, without limitation, surgical needles, staples, scalpels, implants, and surgical tools. It is particularly preferred to utilize surgical needles. In addition, other medical devices can be coated utilizing the process of the present invention including, for example, polypropylene mesh based implants in order to provide improved lubricity for improved deployment, e.g., through a trocar during laparoscopic procedure.

### Coating Processes

Methods of applying silicone coatings to medical devices, including surgical needles, and various coating compositions, are disclosed in U.S. Pat. No. 7,041,088, U.S. Published Patent Application No. 20110112565, and U.S. Pat. No. 5,944,919, which are incorporated by reference herein. The silicone coating compositions useful in the practice of the present invention are applied to one or more surfaces of a medical device using conventional coating techniques and processes, and conventional coating process equipment. The coatings can be applied by, for example, dipping, brushing, rolling, spraying processes, curtain processes, or by any other suitable coating technique.

The coating step can optionally be preceded by a conventional surface finishing or preparation step, such as electropolishing, blackening, cleaning, plasma treatment, or any other surface treatment and preparation step.

Following any surface preparation, solutions of a reactive silicone, such as a hydroxyl or vinyl terminated silicone, having sufficient molecular weight to ensure effective durability and containing a cross-linking agent as described herein below, such as methyl hydrogen polydimethyl siloxane, are applied to one or more surfaces of a medical device, such as a surgical needle.

### Silicone Polymer

The lubricious coating compositions used in the novel processes of the present invention will contain sufficient amounts of silicone polymer to effectively provide a uniform coating of sufficient thickness and functionality on one or more surfaces of a medical device. The silicone coatings useful in the practice of the present invention include conventional silicone coatings containing conventional silicone polymers. The silicone polymers used in the coating compositions include conventional silicone polymers having varying molecular weights and functionalities. The term silicone as used herein refers to polysiloxanes and their derivatives, polydimethylsiloxane derivatives, and any siloxane polymer with suitable functional chemistry having the capability to react with silicone hydride or other suitable cross-linkers. The terms silicones and siloxanes are used herein interchangeably. The preferred polymeric silicones are the polysiloxanes and, in particular, the polyalkylsiloxanes.

Conventional, biocompatible silicones are commercially available for coatings having various molecular weights, end group chemistry, and functional grafting. A preferred and commonly used siloxane is polydimethylsiloxane (PDMS). The polydimethylsiloxanes are typically supplied with proprietary end-group chemistries to facilitate bonding to a metal substrate, and sold and marketed as “lubricious silicone” coatings. The PDMS (polydimethylsiloxane) may be vinyl-terminated, hydroxyl-terminated, or amine-terminated. In order to be useful, they must also be capable of cross-linking for stability and durability. A particularly preferred silicone polymer for use in the processes of the present invention is polydimethylsiloxane that is hydroxyl terminated, such as MED4162 (Nusil 4162) supplied by NUSIL Technology, Caprenteria, Calif. Other commercially available silicones such as Applied Silicone 40114 (available from Applied Silicone Corporation, Santa Paula, Calif.) can also be used for the coatings.

The silicone polymers may include hydroxyl or vinyl terminated silicones in molecular weight ranges typically from about 300,000 to about 800,000 Daltons, preferably from about 400,000-600,000 Daltons.

### Cross-Linking Agent

The lubricious coating compositions used in the novel processes of the present invention will also contain sufficient amounts of at least one cross-linking agent to effectively cross-link the silicone polymer components of the coating compositions, thereby providing durability of the coating through multiple passes through tissue. The cross-linking agents may include methyl hydrogen polydimethyl siloxane, tetraethyl siloxane, or any conventional biocompatible cross-linking agent capable of chemically linking siloxane polymeric chains. The polymeric coating compositions will typically contain up to about 10% by weight of a silicone cross-linking agent, such as a hydride-containing silicone, to facilitate cross-linking of the reactive silicone, and preferably about 4 wt. % to about 6 wt. %. Those skilled in the art will appreciate that other silicones containing functional groups susceptible to plasma excitation can also be used as cross-linking agents. The molecular weight of the cross-linking agents will typically range from about 3,000 Daltons to about 15,000 Daltons, with a preferred molecular weight range of about 4,000 Daltons to about 6,000 Daltons.

The preferred coating formulation will contain methyl hydrogen polydimethyl siloxane as a cross-linking agent of varying molecular weights up to but not limited to 10,000 Daltons. The concentrations of the cross-linking agents used in a coating formulation useful in the practice of the present invention are calculated on the weight of silicone polymer and expressed as a weight percent.

Concentrations of the cross-linking agent are determined with reference to the active end groups present in the silicone, e.g., polydimethylsiloxane, or any suitable siloxane as described above. The concentration of cross-linking agent to siloxane is typically about 1.0 wt. % to about 10.0 wt. % of the weight of siloxane. A preferred concentration of the cross-linking agent is about 2.0 wt. % to about 8.0 wt. % of the siloxane present. The most preferred concentration for a cross-linking agent is about 4.0 wt. % to about 8 wt. % of the total weight of the siloxane present.

### Coating Solutions

According to the present invention, the coatings do not contain a catalyst. Advantages of not having a catalyst (such as for example, organo platinum complex, dibutyl tin dilaurate, or stannous octoate) as a component of the coating solution are related to better biocompatibility, solution stability, and lower cost.

Silicone coating solutions used in the process of the present invention are prepared in compatible solvents such as xylene, toluene, Isopar K or other Isopar-type solvents of suitable vapor pressure. Aqueous systems may also be used, including aqueous emulsions. The total concentration of silicones (including the silicone polymer and the cross-linking agent) in these solvents is typically within the range of from about 5% by weight to about 10% by weight of the total weight of the solution. In one example, a stock (i.e., commercially available) silicone solution in xylene containing between 23 wt. % and 30 wt. % of suitable siloxane with a suitable functionality, such as hydroxyl-terminated PDMS, and 2 wt. % to about 6 wt. % of a cross-linking agent (methylhydrogen PDMS) with the balance of xylene is diluted with any suitable hydrocarbon solvent in which the polymers are soluble, such as Isopar K, xylene, toluene, heptanes, or mixtures thereof to obtain a working coating composition useful in the processes of the present invention. Working coating solutions useful in the practice of the present invention for dip coating will generally contain about 4 wt. % to about 10 wt. % of the silicone and cross-linking agent blend in the solvent, more typically about 4 wt. % to about 8.4 wt. %, and preferably about 6 wt. % to about 8.4 wt. %. Those skilled in the art will appreciate that the concentrations of silicone and cross-linking agent in the solvent may vary depending upon the method of application, desired film thickness, etc.

The solvents that may be used to mix, dilute, and facilitate application of the coating by reducing the viscosity of the coating and adjusting the surface tension of the coating solution include any common, conventionally-used solvent for silicone polymers, including aromatic solvents (e.g., xylene, benzene, toluene), and volatile alkanes such as hexane, heptanes, etc. Aqueous systems may also be utilized. The lower molecular weight, volatile solvents are quite volatile and are generally avoided in practice. A preferred solvent to blend the components of the coating solutions useful in the practice of the present invention is a high molecular weight alkane such as EXXON Isopar K. Isopar K is a less volatile, higher boiling solvent generally considered to be more suitable for manufacturing operations. This solvent is added at a concentration sufficient to allow effective blending of the components of the coating solution. Typically, a sufficient amount of solvent is used to provide effective mixing and coating characteristics to the coating mixture, for example, the amount of solvent present may be about 70-95 wt. % by weight of the mixture.

The mixing of the coating solutions useful in the plasma processes of the present invention will typically be performed in a suitable vessel using a conventional mixing apparatus, such as a high shear mixer. Mixing is typically conducted at room temperature, but other suitable temperatures may be used if desired, depending upon the characteristics of the coating solution. A Cowles impeller mixer and a ball mill are examples of conventional high shear mixers. Mixing times will be sufficient to effectively blend the components of the coating solution, and will depending on various factors including the volume of coating solution being prepared, etc.

### RF Plasma Curing

After applying a silicone coating solution to a surface of a medical device utilizing an acceptable coating process, the articles are optionally air dried to allow excess solvent to evaporate. The viscosity of the applied coating may increase upon drying, and it is believed that this may help to maintain the coating in place. In the practice of the novel processes of the present invention, the treatment of silicone coatings with an RF plasma produces cured and durable, lubricious coatings. Without wishing to be bound by a particular theory, it is theorized that the curing processes may work by cross-linking the reactive end(s) of the silicone polymers functions (e.g., hydrides) available or present on the cross-linking agent.

Plasma treatment of the applied coatings using the methods of the present invention may be accomplished using cold plasma techniques such as radio frequency (RF), microwave, direct current (DC), and the like. In one embodiment, the plasma is RF plasma. The plasma treatment is controlled through certain variables and parameters, including the type of gas utilized, radio frequency, power, duration of treatment, atmospheric pressure, etc.

The type of gas conventionally used for the plasma treatment processes is either a conventional reactive gas, such as oxygen, or a conventional inert gas, such as argon. Typically, reactive gases are used to provide a different chemical composition on the treated surface. In the practice of the present invention, an inert gas is used to physically polymerize the silicone coatings. Suitable inert gases include, but are not limited to, nitrogen, argon, and helium.

When using an RF plasma treatment process in the practice of the present invention, the RF plasma radio frequency will be sufficient to effectively produce the free radicals necessary for the cross-linking reaction within the coating, and typically will be in the range of about 5 MHz to about 100 MHz, preferably in the range of from about 10 MHz to about 45 MHz. In one embodiment, the radio frequency is about 13.56 MHz. In another embodiment, higher radio frequencies in the range of about 30 MHz to about 45 MHz are used. The radiofrequency may also be modulated, i.e., the frequency is changed during the plasma treatment process. The frequency, power, intensity, and modulation of the RF plasma may be tailored to obtain a plasma with the desired characteristics, particularly to decrease ablation. Effective and desired plasma characteristics include a plasma having sufficient energy to generate cross-linking without ablation or negative impact on the coating being produced. The RF power provided to the plasma is sufficient to effectively generate free radicals within the coating to effectively polymerize the polymer coating without causing ablation of the coating, and will typically be between about 5 watts to about 500 watts (W). In one embodiment, the power ranges from about 100 W to 500 W. In another embodiment, the plasma power range may be from 75 W to about 250 W. In yet another embodiment, the power of plasma treatment is about 250 W. The power range will be selected to obtain the desired plasma characteristics. Those skilled in the art will appreciate that type of plasma (RF, DC, microwave, etc.) and power used will vary with the coating system and the outcomes desired.

Optionally, modulation of the RF power level during the plasma treatment process can be employed to modify the curing characteristics. Manual and/or programmed rapid and/or slow changes in the amount of radio frequency energy, i.e., power being supplied to the plasma, are possible. In general, the RF power is set at an initial level, for example 100 watts and subsequently increased and decreased, for example by 25% from the original power setting, at specified intervals over the course of the polymerization period. It is believed that variations in power will affect the plasma's ability to produce free radicals. Free radicals are believed to initiate the cross-linking reaction of the siloxanes. The more power applied, the more likely a higher concentration of free radicals will be produced. But if excessive power is applied, ablation of the coating will possibly result and may compromise the lubricity of the coating. Therefore the power is tuned to result in an optimal amount or rate of cross-linking.

The plasma treatment pressure will be sufficiently effective to provide the desired treatment, and for example, may range from about 0.01 Torr to about 0.50 Torr. In one embodiment, plasma treatment pressure is about 0.03 Torr. It is believed that the lower the pressure, the lower the concentration of the free molecules with a resultant increase in the mean free path, thus resulting in higher velocity of ions or molecules or electrons and higher collisional intensity.

The duration of plasma treatment will be for a sufficient period of time to provide effective treatment that results in a durable, lubricious coating, and is directly related to the degree of polymerization of the siloxane coating, and, for example, may range from about 10 minutes to about 45 minutes, or an adequate period of time to provide sufficiently effective cross-linking. In one embodiment, the duration of plasma treatment is from about 20 minutes to about 30 minutes.

In one embodiment, polymeric or metallic samples are placed in the center of the plasma on a non-biased shelf, which is essentially a floating electrode, with the chamber pressure at 0.03 Torr. In still other embodiments, the electrode on which the sample is placed is electrically connected to an RF generator and/or a DC bias is applied.

The plasma vacuum chamber or equipment useful in the practice of the processes of the present invention will have a conventional configuration and will typically consist of a conventional chamber that has an inlet and an outlet port. The inlet port is used for feeding in the gas of interest. The flow rate is controlled in a conventional manner, for example, by a mass flow controller. The outlet port is connected to a source of suction, such as a vacuum pump, and is used to evacuate the chamber to remove air and also remove excess gas flowing in. The chamber itself has metallic electrodes through which high voltage can be applied to generate a plasma with the gas of interest.

As a result of the RF plasma treatment, the polymeric silicone coatings are cured and cross-linked on the surface or surfaces of the medical devices. The thicknesses of the silicone coatings obtained using the processes of the present invention will typically range from about 1 to about 20 microns, more preferably from about 1 to about 10 microns. As a result of the RF plasma treatment, the coating is fully or at least partially cross-linked, with the degree of cross-linking comparable to the heat treated samples, as measured by the insoluble (cross-linked) fraction. In plasma the comparable degree of cross-linking can be achieved in 30-60 minutes, while thermal treatment requires up to 5 hours at 190° C.

The novel methods of the present invention using plasma treatment to cure silicone coatings on one or more surfaces of medical devices, including surgical needles, have numerous advantages. One advantage is that plasma cured coatings eliminate the need for catalyst to reduce the curing reaction time. Also, since the chamber is at low pressure, residual solvents and unreacted species can also be removed from the needle's surface. Still another advantage is that since the plasma's intensity can be precisely controlled, a reliable process can be developed that ensures predictable out comes from the coating process.

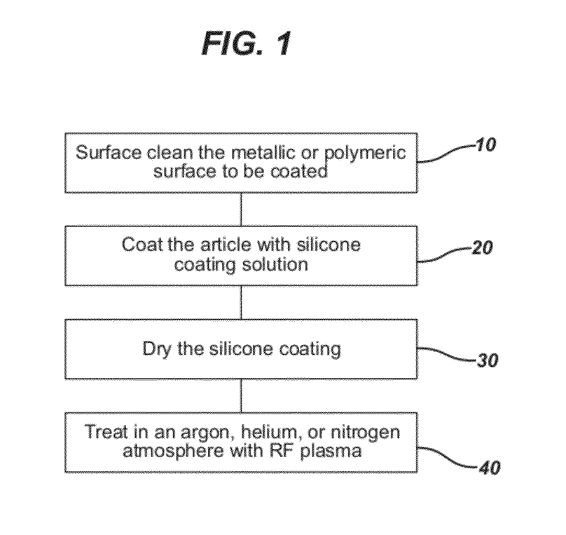

A schematic block-diagram shown in FIG. 1 illustrates a needle coating process according to an embodiment of the present invention. According to an embodiment of the present invention, the process includes the following process steps. In step 10, the metallic or polymeric surfaces of a medical device are optionally cleaned to remove contaminants associated with the manufacturing of the article, e.g. grease, dust, lacquer, etc. Proceeding then to step 20, the surfaces are coated with a silicone coating solution using a coating solution and coating process as previously described herein or an equivalent. In optional step 30, the coated surfaces of the medical device are dried at ambient conditions, such as in air at room temperature and pressure. The coated medical device is transferred to a plasma chamber for the plasma treating step 40. In step 40, the coated surfaces of the device are treated in a gaseous atmosphere (e.g., an argon, helium, or nitrogen) with RF plasma under sufficiently effective conditions to cure the coating and the device is then removed from the chamber.

According to the present invention, it has been discovered, surprisingly and unexpectedly, that RF plasma treatment, which is typically used for a destructive treatment, such as cleaning, resulted in a durable lubricious coating, when RF plasma treatment was applied to a silicone coating on a surface of a medical device. Surprisingly, the coating in absence of any catalyst was successfully cured by RF plasma, and with a much shorter cycle time versus conventional thermal curing processes. The absence of catalysts enhances the biocompatibility of silicone coatings due to the absence of heavy metals such as tin or platinum.

The following examples are illustrative of the principles and practice of the present invention although not limited thereto.

### Example 1

### Preparation of the Coating Solution

A commercially available stock solution (obtained from NuSil Silicones Corp., MED1 4162) containing between 23-30 wt. % of total solids, which are silicone polymers, including 2-6 wt. % of the cross-linking agent (methylhydrogen PDMS) with the balance of the total weight being xylene was transferred into a suitable mixing vessel and diluted with Exxon Isopar K isoparrafinic hydrocarbon to obtain a working solution containing approximately by weight 6% hydroxy-terminated polydimethylsiloxane, up to 1.2 wt. % methylhydrogen siloxane, about 15 wt. % xylene, and about 77.8 wt. % Exxon Isopar K isoparrafinic hydrocarbon. Mixing was performed using a high shear mixer (Cowles) for about 10 minutes at room temperature. The coating solution did not contain any catalyst. The working solution was then used to dip coat surgical needles as described in Example 2.

### Example 2

### Dip Coating

Straight, taper point stainless steel needles (23 mils in diameter) were obtained from a conventional surgical needle manufacturing process. The needles were degreased by plasma cleaning in a typical tetrafluoromethane/oxygen plasma. The plasma was run at about 100 W using a commercially available plasma treatment system, specifically Plasma Technology System, Model # PS0150, RF Chamber having a 500 Watt RF power source; the system had three mass flow controllers. The make-up gas used was 60% by volume tertafluoromethane and 40% oxygen as a gas atmosphere at about 0.05 torr for about 30 minutes. The needles were clamped in a conventional needle holder individually at the base of each needle. The needles then were dip coated by immersing the needles once into a conventional 1 liter dip tank containing the working solution, as described in Example 1, for several seconds. The needles were then lifted up and out from the tank and placed with their tips facing upward in a holding block needle-holder. The needles were then allowed to air dry for up to 4 hours at ambient conditions.

### Example 3

### Plasma Curing

Plasma curing was performed utilizing a commercially available plasma treatment system, specifically Plasma Technology System, Model # PS0150, RF Chamber having a 500 Watt RF power source; the system had three mass flow controllers. The coated needles with coatings applied by a dipping process as described in Example 2 were positioned using the holding block needle-holder into the RF chamber. Vacuum was then applied to establish a base pressure of about 0.01 ton. Helium purge gas flow was established at 20-50 cc/min. RF power was then applied at 450 watts, and vacuum in the chamber was maintained at 30-40 mTorr, and the frequency was 13.56 MHz unmodulated. After 30 minutes of treatment, the chamber was brought to atmospheric pressure, and the needles removed from the chamber for testing. The coatings were tack-free when removed. It was also observed that the silicone coatings were completely cured, that is, polymerized as evidenced by a lack of tackiness.

### Example 4

### Needle Performance Evaluation

The coated needles of Example 3 were analyzed for lubricity and durability in the following manner The equipment used was a Texture Analyzer, Model TA.XT Plus, running Texture Exponent 32 software made by Stable Micro Systems, Scarsdale, N.Y., and equipped with a suitable fixture to hold each needle being tested. The texture analyzer drove the needles at 5 mm/min cross head speed, with Red Septum rubber (3.35 mm thick and having hardness characterized by Shore A of 65, supplied by McMaster Carr of Chicago, Ill.) used as the test media. The needles were held in the Texture analyzer in a custom made needle chuck.

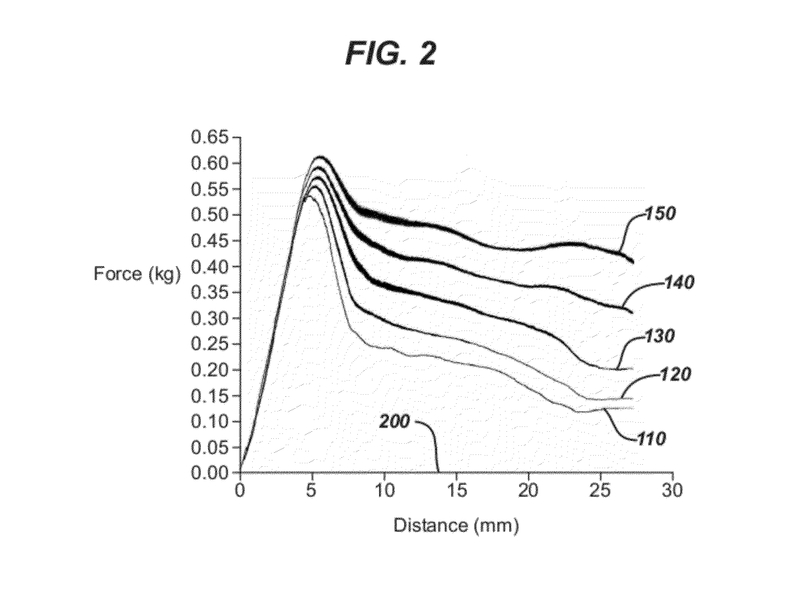

The silicone-coated and RF plasma treated needles were tested by measuring the force needed to push them through the rubber media. The resulting force was plotted as a function of the displacement of the needle. FIG. 2 presents experimental data for a single needle as a plot of force (kg) applied to the coated needle to pass through the rubber sheet test media as a function of penetration distance (mm) and number of passes through the media. The first peak indicates the perforation of the substrate, while the following plateau from about 8 mm and higher represent the needle drag, associated with the straight body of the needle, with the height of the plateau at the distance of 15 mm (indicated by the reference numeral 200 on the chart) indicating the needle lubricity. Similar experimental were obtained on multiple needles (typically 10 needles were used and 10 penetration tests were performed) and the average results analyzed.

The five curves shown in the plot of FIG. 2 correspond to increasing number of passes of the needle through the media, from the lowest curve designated with reference numeral 110 corresponding to pass 1, to the highest curve designated with the reference numeral 150, corresponding to pass 5, with curves designated 120, 130, and 140 corresponding respectively to passes 2, 3, and 4, respectively. The extent of the increase in needle drag with the number of passes is an indication of the durability of the coating. The data indicates that with each consecutive penetration the lubricity is decreasing due to wear of the coating.

### Example 5

### Comparative Study

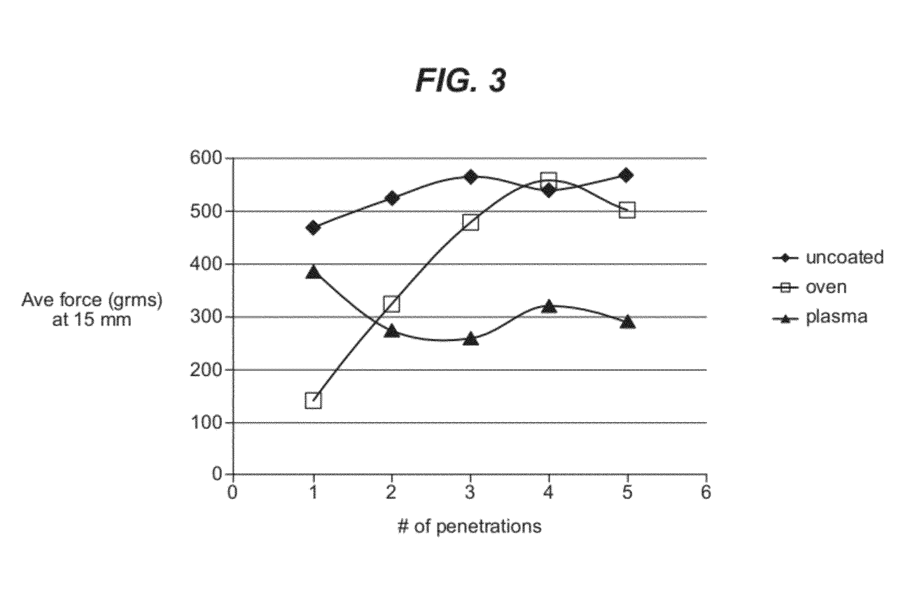

A comparative study of silicone-coated needles was performed, with RF plasma cured coating as described in Example 3 tested in comparison with similar needles having thermally cured coatings and in comparison with un-coated needles. The thermally cured coatings were applied to the same test needles described in Example 2 by dip coating using the same process as described for the plasma cured needle coatings in Example 2. The coating solution used for the thermally cured coatings was exactly the same as that used for the RF treated coatings and is described in Example 1. The comparative thermally cured needles were then subjected to thermal curing in an air atmosphere in a conventional oven at 195° C. for 4 hours. No catalysts were used in the coating solutions for the thermally cured needles. FIG. 3 shows a plot of the needle drag at 15 mm needle penetration depth as a function of the number of passes for needles with the plasma treated coating and needles with the heat treated coating versus un-coated needles. The data of FIG. 3 are also shown in Table 1. Five needles were used for obtaining each average data point shown in FIG. 3 and in Table 1. As can be seen from FIG. 3 and Table 1, similar needles coated with the same coating and thermally treated in an oven showed a markedly higher increase in the average body drag as measured in the test media versus the RF plasma treated needles. Results on the comparative performance testing of the needles showed that the plasma treatment produced a more durable lubricious coating as indicated by lower drag resistance increase over the number of passes through the media.

TABLE 1
Needle drag force (g) at 15 mm needle
penetration average of five needles

| Curing type | Pass 1 | Pass 2 | Pass 3 | Pass 4 | Pass 5 |
|---|---|---|---|---|---|
| Un-coated | 472.4 | 526.8 | 567.4 | 543.4 | 571 |
| needle | | | | | |
| Thermal | 142 | 326.4 | 480 | 559.2 | 504 |
| RF plasma | 387.8 | 276.6 | 261 | 322.8 | 293 |

Importantly, the data in FIG. 3 indicate that the plasma curing process of the instant invention results in a durable and lubricious coating, obtained in shorter time and with a more reliable process versus the standard heat curing process. The reliability of the process was demonstrated by a more easily performed and tuned RF treatment process. Furthermore, the needle drag force of the needles having a thermally cured coating was shown to increase substantially faster with each pass through the test media than the needle drag force of the needles having the RF plasma cured coating, indicating faster wear.

### Example 6

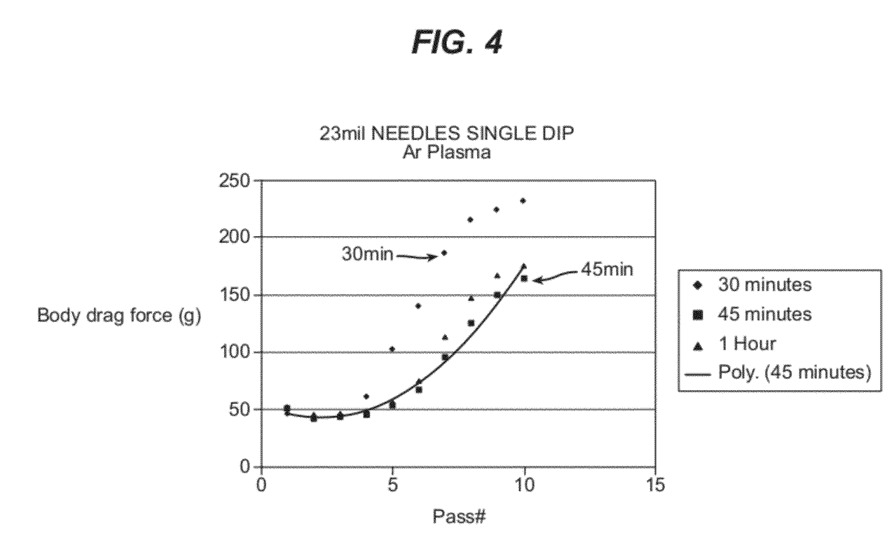

Referring now to FIG. 4, the results of the testing of needles coated with RF plasma cured coatings are shown. The coatings were applied in the same manner as described in Examples 1 and 2, RF plasma treated as described in Example 3, but with different RF plasma treatment times, and then performance evaluated as described in Example 4.

FIG. 4 shows a plot of the needle drag at 15 mm needle penetration depth as a function of the number of passes for 23 mil needles, single dip coated, and with argon RF plasma treated coatings. Ten needles were used for obtaining each average data point shown in FIG. 4. As can be seen from FIG. 4, a high quality lubricious coating was obtained by RF plasma curing of the coating in absence of catalysts and using a short cycle time of 30 minutes to 60 minutes. RF plasma curing of the coating for 30 minutes resulted in practically identical coating performance as RF plasma curing for 45-60 minutes, for up to 3 passes through the test media. However, for the number of penetration passes of 4 to 10, coatings cured by RF plasma for 45-60 minutes demonstrated better performance (i.e., lower body drag) compared to coatings which were RF plasma cured for 30 minutes.

Although this invention has been shown and described with respect to detailed embodiments thereof, it will be understood by those skilled in the art that various changes in form and detail thereof may be made without departing from the spirit and scope of the claimed invention.

I claim:

1. A method of curing a coating a medical device, comprising:
applying a coating solution to a surface of a medical device, the coating solution comprising a silicone polymer, a silicone-containing cross-linking agent, and a solvent, wherein the coating solution does not contain a catalyst; and,
exposing the coated surface to a plasma for a sufficient period of time to effectively cure the silicone polymer.

2. The method of claim 1, wherein the plasma comprises a gas selected from the group consisting of argon, helium, nitrogen, and combinations thereof.

3. The method of claim 2, wherein the gas is helium.

4. The method of claim 1, wherein the silicone polymer is selected from the group consisting of hydroxyl terminated polydimethylsiloxane, vinyl terminated polydimethylsiloxane, and combinations thereof.

5. The method of claim 4, wherein the silicone-containing cross-linking agent comprises methyl hydrogen polydimethyl siloxane.

6. The method of claim 1, wherein the coating has a thickness of about 2 microns to about 10 microns.

7. The method of claim 1, wherein the plasma has an applied power of about 5 watts to about 500 watts.

8. The method of claim 1, wherein the plasma has a pressure of about 0.01 torr to about 1 torr.

9. The method of claim 1, wherein the solvent comprises an organic solvent.

10. The method of claim 1, additionally comprising the step of air drying the coating prior to exposing the coating to the plasma.

11. The method of claim 1, wherein the solvent is selected from the group consisting of xylene, toluene, benzene, heptanes, Isopar K, and blends thereof.

12. The method of claim 1, wherein the medical device comprises a surgical needle.

13. The method of claim 1, wherein the medical device comprises a surgical mesh.

14. The method of claim 1, wherein the concentration of the silicone polymer and the cross-linking agent in the coating solution is about 4.0 wt. % to about 10.0 wt. %.

15. The method of claim 1, wherein the cross-linking agent comprises a hydride-containing silicone polymer.

16. The method of claim 1, wherein the plasma is selected from the group consisting of RF plasmas, microwave plasmas, and direct current (DC) plasmas.

17. The method of claim 1, wherein the medical device comprises a material selected from the group consisting of metals, alloys, polymers, ceramics, glasses, composites, and combinations thereof.

18. The method of claim 16, wherein the plasma comprises and RF plasma.

19. The method of claim 18, wherein the RF plasma has a frequency of about 5 MHz to about 100 MHz.

20. The method of claim 19, wherein the frequency is modulated.
